(19) United States
(12) Patent Application Publication
(10) Pub. No.: US 2009/0315853 A1
(43) Pub. Date: Dec. 24, 2009

(54) MULTI-INDUCED TOUCHPAD

(75) Inventors: YAN-MEI YANG, Kaohsiung (TW); Chung-Yi Shen, Kaohsiung (TW)

Correspondence Address: G. LINK CO., LTD., 3550 BELL ROAD, MINOOKA, IL, 60447, US

(73) Assignee: SENTREND CORPORATION, Kaohsiung (TW)

(21) Appl. No.: 12/196,285

(22) Filed: Aug. 22, 2008

(30) Foreign Application Priority Data
Jun. 20, 2008 (TW) 097122977

(51) Int. Cl. G06F 3/045

(52) U.S. Cl. 345/174

(57) ABSTRACT

A multi-induced touchpad sequentially includes a protect layer, a first axis locus, an insulation layer, a multi-induced layer, a space dot layer, a conductive film and a substrate. The first axis locus layer has the first axis locus and the multi-induced layer has the second axis locus and a conductive circuit is provided at the first axis locus layer and the multi-induced layer respectively. The respective axis locus is intersected to each other and the conductive circuit is connected to the axis locus respectively for transmitting the conductive inducing signal to a subsequent signal processing component. The second axis locus has an electrical node at an end thereof and the conductive film has an electrical node thereon for connecting with a voltage source and a resistance calculation circuit such that the induced signal at the presses spot can be created and figured out.

### BACKGROUND OF THE INVENTION

1. Field of the Invention

The present invention is related to a multi-induced touchpad and particularly to a touchpad which not only combines advantages of the resistance type and the capacitance type touchpad but also decreases induction layers of the touchpad.

2. Brief Description of the Related Art

The touchpad has almost become a universal component for an electronic product with a pointing device owing to the unceasingly development of the portable and interactive electronic products. In order to meet demand of the market, the quality and the effectiveness of the produced touchpad are incessantly enhanced. Due to the quantity being promoted and the cost being reduced, the touchpad has been employed widely in the various electronic products. In general, the structure of the touchpad can be classified into four different types in accordance with the principle of the application. They are the resistance type touchpad, the capacitance type touchpad, the sound wave type touchpad and the optical type touchpad. The four types of the touchpad have different manufacturing processes, functions, operations, advantages and deficiencies. More over, the four types of the touchpad have their own applications based on their characteristics. The resistance type touchpad is induced with the press point such that no restriction to the touching medium. For instance, a finger, a pencil, a credit card or a finger with a glove can operate the touchpad. In addition, the resistance type touchpad has a cheap cost such that it is mostly used in the consuming electronic products such as the cell phone, the personal digital assistant (PDA) and the global positioning system (GPS). The capacitance type touchpad is fabricated with more complicated manufacturing process and the control chip and the circuit provided in the capacitance type touchpad are more complicated than the resistance type touchpad too. Therefore, the capacitance touchpad is mostly employed with the high price electronic products such as the laptop computer and the bank automatic teller machine (ATM). Due to the technology and the manufacturing process related to the sound wave type touchpad and the optical type touchpad have not been developed maturely yet, the sound wave type touchpad and the optical type touchpad are mostly employed with the big size and high price electronic products.

The resistance type touchpad has a basic structure with an upper soft conductive plate, a lower conductive plate and a spacing layer formed of a plurality of space dots is disposed between the upper soft conductive plate and the lower conductive plate. In practice, one of the two conductive plates is subjected to a voltage difference at the two lateral sides thereof and the upper soft conductive plate is pressed downward such that the pressed spot deformed downward to touch the lower conductive plate and the potential of the pressed spot can be measured via another conductive plate. In this way, the relation of the surface resistance of the conductive plate with respect to the distance is taken to figure out the position of the pressed spot corresponding to the two lateral sides, which, for instance, are the two lateral sides along the X-direction. Similarly, another two lateral sides, which, for instance, are the Y-direction, can create a voltage difference via circuit switch to obtain the position of the pressed spot corresponding to another two lateral sides. A hard medium such as a finger, a pencil or a credit card can be adopted to touch the resistance type touchpad and the resistance type touchpad is especially suitable for the small sized product or the product needing a small clicking area such as the GPS, the drawing board or hand-writing board. However, it is required to pressingly touch and click the resistance type touchpad while in operation so that the system is easy to be worn out and the material is easy to be strain-fatigued. Therefore, the resistance type touchpad has a limited life span and it is not suitable for constant usage or being used in the public place. Furthermore, if the medium, such as a bigger finger or a blunt object, is used to press a slightly larger area, the position of the pressed spot is incapable of being measured out. Besides, the surface resistance on the conductive film changes with the temperature and it results in a deviation of the distance calculated by the resistance type touchpad so that it is not appropriate to operate in an environment with higher temperature.

The capacitance type touchpad has a basic structure with an X-axis inducing layer, a Y-axis inducing layer and an insulation layer between the X-axis inducing layer and the Y-axis inducing layer. The X-axis inducing layer has an X-axis locus along the X-axis and the Y-axis inducing layer has a Y-axis locus along the Y-axis. In practice, the conductor (a finger or a conductive object) touches the touchpad slightly and the position touched by the conductor can be figured out by means of a voltage change created by a capacitance effect, which is formed with the X-axis locus and the Y-axis locus. The capacitance type touchpad has many advantages including the function of touch-control can be reached conveniently with a tip. In addition, the surface of the touchpad is touched slightly only so that there are no problems with the touchpad being worn out and deformed and the life span of the touchpad is longer and suitable for being constantly operated at the public place. Besides, the capacitance induction is fast in response so that the operation time of the capacitance type touchpad is shorter that that of the resistance type touchpad. Especially, the capacitance type touchpad is capable of controlling multiple touched spots and this is an advantage not being reached with the resistance type touchpad, which only can control a single touched spot.

However, the capacitance type touchpad is liable to be interfered with the foreign electromagnetic wave and produces an error action. Further, the induced capacitance has to be corrected with the inductions from the human body, the ambient temperature and the ambient humidity constantly. In addition, when the finger operates the capacitance type touchpad, the inner large surface area of the fingertip has to be used to touch the touchpad instead of the tip point of the fingertip, which is done with the resistance type touchpad. Hence, the capacitance type touchpad is not suitable for a map click system, a drawing system or a handwriting system although the preceding deficiencies can be overcome with a special inducing pen. Hence, the capacitance type touchpad does not fit the small sized control area and it is incapable of providing the convenience of light finger touch.

As the foregoing, the resistance type touchpad and the capacitance type touchpad have the functions, features, advantages and disadvantages their own. If there is a touchpad capable of combining these features and recovering these disadvantages, the touchpad would be more convenient and widespread in its applications.

Referring to FIGS. 1 and 3, Taiwan Utility Model No. M321553, entitled “A TOUCHPAD WITH DOUBLE INDUCING INTERFACE” is illustrated. The prior art discloses a composite pad with a capacitance touchpad board A stacking with and a resistance touchpad board B. The capacitance touchpad board A further has a top plate 10, a first axis locus inducing layer 11, a first insulation layer 12, a second axis locus inducing layer 13. The resistance touchpad board B further has a second insulation layer 14, an upper conductive film 15, a space dot area 16, a lower conductive film 17 and a bottom plate 18. In fact, the prior art provides that the capacitance type touchpad is simply accumulated to the resistance type touchpad directly without changing the original structures and the circuits thereof. In this way, the user can switch to operate the capacitance type touchpad or the resistance type touchpad with a manual switch or a signal judgment circuit and the signal produced with the touchpad A or the touchpad B is sent to a signal processing unit. However, the original structures of the capacitance type touchpad and the resistance type touchpad are kept while the composite touchpad is fabricated, it is unable to reduce the gross volume of the composite touchpad and lower the production cost. As a result, not only more assembled components make the structure thereof more complicate but also the touchpad occupies a lot of space. Hence, the composite touchpad is costly and it leads to the undesirable acceptance of the users.

Thus, how to offer a multi-induced touchpad, which is capable of offering the advantages of both the resistance type touchpad and the capacitance type touchpad and reducing the manufacturing process, the cost and the gross volume, is the goal that the present inventor pursues.

### SUMMARY OF THE INVENTION

In order to overcome the deficiencies of the preceding prior art, a primary object of the present invention is to provide a multi-induced touchpad, which needs three inducing layers only for inducing the induction signal of the capacitance type and the resistance type touchpad. The simplified laminated structure allows the reduced signal circuit with an integrated control chip such that the production cost and the fabricating steps can be diminished and the integral shape with lightness and thinness can be achieved substantially.

Accordingly, A multi-induced touchpad sequentially according to the present invention includes a protect layer, a first axis locus layer, an insulation layer, a multi-induced layer, a space dot layer, a conductive film and a substrate. The protect layer is acted as a contact surface for isolating the electrical short circuit. The first axis locus layer and the multi-inducing layer have a conductive locus respectively for inducing the weak capacitance on the finger or the conductor for the capacitance calculation unit analyzing the capacitance change of the circuit. The multi-inducing layer and the conductive film electrically connect with the power source and the resistance calculation circuit respectively for exerting a voltage difference to the multi-inducing layer or the conductive film for figuring out the resistance at the pressed spot to achieve the multi-inducing effect.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a block diagram of the conventional double inductive interface touchpad illustrating the layer structure thereof;

FIG. 2 is a block diagram of a multi-inductive touchpad according to the present invention illustrating the layer structure thereof;

FIG. 3 is a flow chart of the inductive signal of the conventional double inductive interface touchpad being processed;

FIG. 4 is a flow chart of the inductive signal of the multi-induced touchpad according to the present invention being processed;

FIG. 5A is a plan view illustrating the layer structure of a multi-induced touchpad according to the present invention;

FIG. 5B is a plan view illustrating a layout of the first axial locus layer of a multi-induced touchpad according to the present invention; and

FIG. 5C is a plan view illustrating a layout of the multi-induced layer of a multi-induced touchpad according to the present invention;

### DETAILED DESCRIPTION OF THE INVENTION

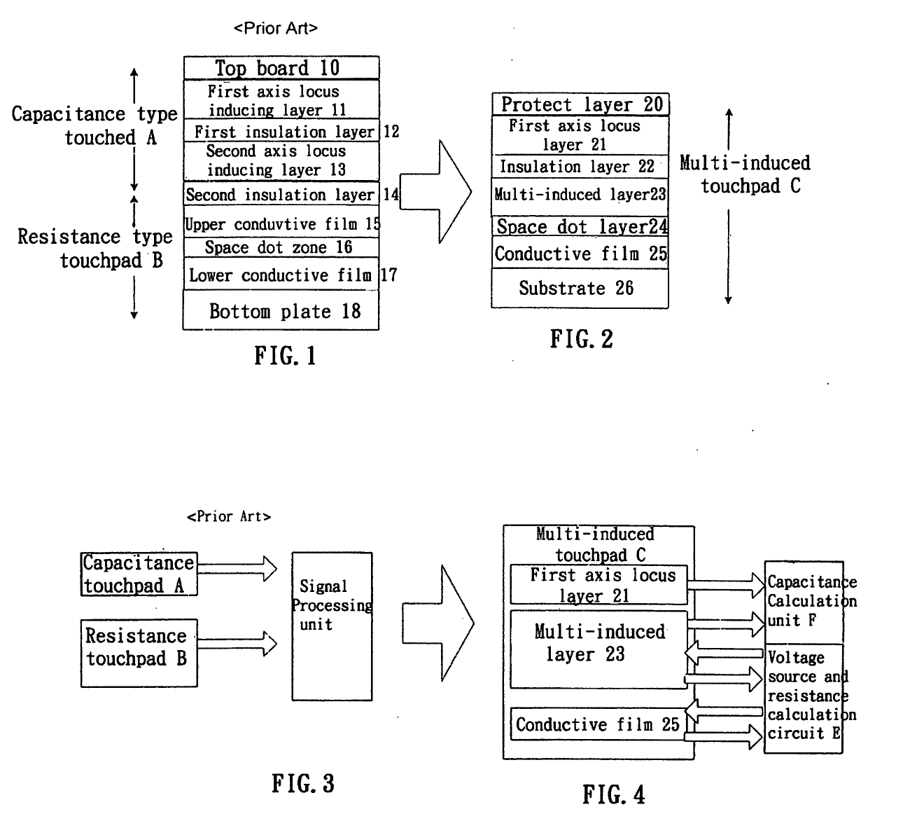

Referring to FIGS. 2 and 4, the preferred embodiment of a multi-induced touchpad according to the present invention is illustrated. The multi-induced touchpad C has a laminated structure and includes a protect layer 20, which is made of an insulation material, a first axis locus layer 21, an insulation layer 22, a multi-induced layer 23, a spacing dot layer 24, a conductive layer 25 and a substrate 26. The prior art shown in FIG. 1 at least provides four induced layers in which there are two capacitance type induced layers 11, 13 and two resistance type induced layers 15, 17. Comparing to the prior art, the multi-induced touch pad C of the present invention provides three induced layers, a first axis locus layer 21, a multi-induced layer 23 and a conductive film 25, which are designed to comply with the capacitance type induction and the resistance type induction. The axis locus layer 21 and the multi-induced layer 23 can induce the weak capacitance on a finger or a conductor. Further, the multi-induced layer 23 can be pressed to contact the conductive film 25 for obtaining the position of the pressed spot by means of the external power and the resistance-calculation circuit figuring out the circuit resistance at the pressed spot. The first axis locus layer 21 and the multi-inducing layer 23 have a conductive locus respectively for inducing the weak capacitance on the finger or the conductor for the capacitance calculation unit F analyzing the capacitance change of the circuit. The multi-inducing layer 23 and the conductive film 25 electrically connect with the power source and the resistance calculation circuit E respectively for exerting a voltage difference to the multi-inducing layer 23 or the conductive film 25 for figuring out the resistance at the pressed spot to achieve the multi-inducing effect.

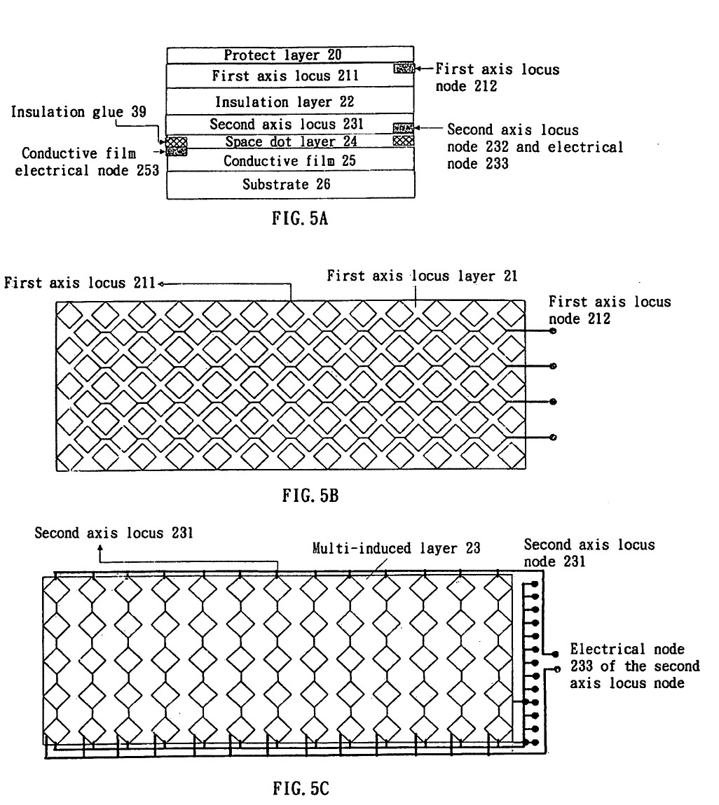

FIGS. 5A, 5B and 5C show an implementation of the first axis locus layer 21 and the multi-induced layer 23. The first axis locus layer 21 has a first axis locus 211 and an axis locus node 212 at an end of the axis locus 211, and the axis locus node 212 is connected to a conductor circuit to transmit the capacitance induction signal to a capacitance operation unit F. Besides, the multi-induced layer 23 has a second axis locus 231 and an axis locus node 232 at an end of the axis locus 231, and the axis locus node 232 is connected to a conductor circuit to transmit the capacitance induction signal to the capacitance operation unit F too. The first axis locus 211 and the second axis locus 231 are arranged to intersect in a way of two-dimensional distribution and the insulation layer 22 acts as an isolation of electrical short circuit such that the induced signals of the axis loci are combined to receive the two-dimensional operation messages of the nodes 212, 232.

Referring to FIG. 5C again, the multi-induced layer 23 further includes an electrical node 233 at an end of the second axis locus and a plurality of space dots are arranged between the second axis locus 231 and the conductive film 25 with an insulation glue 39 provided at the outer surface of the respective space dot for being joined to the multi-induced layer and the conductive film. The conductive nodes has an electrical node 253, and the electrical node 253 and the electrical node 233 of the second axis locus 231 are connected to the external power source and the resistance operation circuit E (shown in FIG. 4) such that the resistance operation circuit E can figure out the operation message of the press spot at the two-dimensional space by means of the voltage difference supplied by the power source and the voltage at the press spot.

The operations of the second axis locus 231 and the conductive film 25 are explained hereinafter. The conductive film 25 is arranged to have two pairs of directional electrical nodes, i.e., a pair of the directional arrangements are along the x-axis and the other pair of the directional arrangements are along Y-axis. An X-direction voltage difference is offered at the first time interval and a Y-direction voltage difference is offered at the second time interval. When the conductive film 25 has an X-direction voltage difference, the message of the pressed spot along the X-direction can be obtained by means of the resistance calculation circuit figuring out the voltage at the second axis locus. When the conductive film 25 has a Y-direction voltage difference, the message of the pressed spot along the Y-direction can be obtained by means of the resistance calculation circuit figuring out the voltage at the second axis locus.

The alternative operations of the second axis locus 231 and the conductive film 25 are explained hereinafter. The conductive film 25 is arranged to have a single pair of directional electrical nodes, i.e., the directional arrangement along the X-axis offers an X-direction voltage difference. The directional arrangement of the electrical nodes of the second axis locus 231 offers a voltage difference intersecting the X-direction voltage difference such as a Y-direction voltage difference. Further, the X-direction voltage difference and the Y-direction voltage difference are sequentially offered at an individual time interval respectively. In this way, when the X-direction voltage difference of the conductive film 25 is offered, the X-direction message of the contact spot can be obtained by means of the resistance calculation circuit figuring out the voltage at the second axis locus. When the Y-direction voltage difference of the second axis locus 231 is offered, the Y-direction message of the pressed spot can be obtained by means of the resistance calculation circuit figuring out the voltage at the conductive film 25.

In practice, the protect layer 20 is a thin insulation layer made of a transparent material such as the polyester (PET) film such that the entire touch pad is light-penetrable with the circuit underneath being capable of running under a condition of isolating the moisture. Further, a hard coating can be provided at the upper surface of the protect layer 20 to reinforce the hardness thereof for offering an anti-scratching and anti-staining work surface. The substrate 26 is disposed under the conductive film 25 and made of hard material against pressing. Preferably, the substrate 26 can be made of Indium-Tin Oxide (ITO) coating glass. The substrate 26 can be light-penetrable as well to adapt to the light-penetrable touch pad and applying to the touch screen and the illuminant touch pad. The substrate 26 can be made of polycarbonate fiber plastics and/or the circuit made of the polycarbonate fiber plastics. The conductive film 25 can be ITO, gold, silver or copper foil or can be the conductive printing ink. The electrical circuit or control circuit required by the system can be printed to the bottom side of the substrate directly like a printed circuit. In addition, the electrical nodes on the conductive film can be arranged to pass through the guide holes provided at the substrate 26 for connecting with the circuit.

In the preferred embodiment, the first axis locus 211 and the second axis locus 231 can be individually plated on a facial side of an insulation film, such as the PET film, respectively. Then, the respective insulation film is adhered to each other with glue to form the first axis locus layer 21, the insulation layer 22 and the multi-induced layer 23. If the first axis locus 211 is the glued side, the insulation film with the first axis locus 211 is the protect layer 20. Alternatively, the first axis locus and the second axis locus 231 can be fabricated on the facial side and the bottom side of the insulation layer 22 directly as shown in FIG. 5A. For example, two flat sides of a PET film are printed or plated with the first axis locus 211, the second axis locus 231, the locus nodes 212, 232 and the electrical node 233 respectively to form the first axis locus layer 21, the insulation layer 22 and the multi-induced layer 23 without the glue layer.

While the invention has been described with referencing to preferred embodiments thereof, it is to be understood that modifications or variations may be easily made without departing from the spirit of this invention, which is defined by the appended claims.

What is claimed is:

1. A multi-induced touchpad comprising:
a protect layer, which is an insulation film;
a first axis locus layer having a first axis locus made with a good conductive rate and having a first locus node being disposed at an end of said first locus;
an insulation layer being an insulation film too;
a multi-induced layer having a second axis locus made with a good conductive rate and a first electrical node, and a second locus node being disposed at an end of said second locus;
a space dot layer being arranged with a plurality of space dots;
a conductive film made with a good conductive rate and having a second electrical node; and
a substrate made of an insulation material;
wherein, said protect layer, said first axis locus layer, said insulation layer, said multi-induced layer, said space dot layer, said conductive film and said substrate are stacked sequentially; said first locus node and said second locus node are connected to a conducting circuit for transmitting a charge-inducing signal to a signal processing component; and said first electrical node and said second electrical node are electrically connected to a voltage source and a resistance calculation circuit respectively.

2. The multi-induced touchpad as defined in claim 1, wherein said voltage source connected to said second electrical node offers a voltage difference between a first direction and a second direction, which are intersected each other; said resistance calculation circuit figures out a resistance value of a pressed spot at said two directions respectively.

3. The multi-induced touchpad as defined in claim 1, wherein the voltage source of said second electrical node offers a voltage difference of said first direction and the resistance calculation circuit of said first electrical node figures out a resistance value of said pressed spot at said first direction; the voltage source of said first electrical node offers the voltage difference of said second direction; and resistance calculation circuit of said second electrical node figures out a resistance value of said pressed spot at said second direction.
